(19) United States
(12) Patent Application Publication
(10) Pub. No.: US 2022/0269746 A1
(43) Pub. Date: Aug. 25, 2022

(54) System and Methods for Standardizing Scoring of Individual Social Media Content

(71) Applicant: LIFEBRAND LLC, West Chester, PA (US)

(72) Inventors: Thomas J. Colaiezzi, West Chester, PA (US); Jemma Barbarise, West Chester, PA (US); Jan Urban, Prague 2 (CZ); David Reinberger, Prague 2 (CZ); Ugur Oruc, Prague 2 (CZ); Veronika Madzinova, Prague (CZ); James Fiala, Guelph (CA)

(21) Appl. No.: 17/680,198

(22) Filed: Feb. 24, 2022

Related U.S. Application Data
(60) Provisional application No. 63/152,889, filed on Feb. 24, 2021.
(60) Provisional application No. 63/152,892, filed on Feb. 24, 2021.
(60) Provisional application No. 63/152,904, filed on Feb. 24, 2021.

(51) Int. Cl. G06F 16/9535; G06Q 50/00; G06N 3/04

(52) U.S. Cl. CPC G06F 16/9535; G06Q 50/01; G06N 3/04

(57) ABSTRACT

The disclosed embodiments provide systems and methods analyzing social media content using artificial intelligence/machine learning algorithms. In certain embodiments, the system collects social media data from one or more third-party social media networks associated with the user, where the social media data is comprised of two or more of post reactions, post comments, posting frequency, profile picture, public posting setting, grammar, and predetermined keywords. The system then analyzes, using a machine learning algorithm, the social media data of the user to calculate a social impact score for the user, and transmits the social impact score to the user. In some embodiments, the social impact score is calculated relative to other social impact scores.

### CROSS-REFERENCE TO RELATED APPLICATIONS

This application claims the benefit of U.S. Prov. App. Nos. 63/152,889, 63/152,892, and 63/152,904, each of which is hereby incorporated in its entirety by reference.

### FIELD OF THE INVENTION

The present invention relates to methods, apparatus, and systems, including computer programs encoded on a computer storage medium, for collecting and analyzing social media posts across multiple social media platforms to address possible harmful posts.

### BACKGROUND OF THE INVENTION

Artificial intelligence (AI) is the name of a field of research and techniques in which the goal is to create intelligent systems. Machine learning (ML) is an approach to achieve this goal. Deep learning (DL) is the set of latest most advanced techniques in ML.

The execution of machine learning models and artificial intelligence applications can be very resource intensive as large amounts of processing and storage resources can be consumed. The execution of such models and applications can be resource intensive, in part, because of the large amount of data that is fed into such machine learning models and artificial intelligence applications.

Current tools used in social media involve word-matching, which looks for the occurrence of the query words in social media posts. This type of search is not efficient because the presence or absence of words of the query compared to the quantity of social media does not necessarily confirm the relevance or irrelevance of the found documents. For example, a word search might find documents that contain words but that are contextually irrelevant. Or, if the user applied a different terminology for the query that is contextually or even texturally different than the one in the documents, the word-matching process would fail to match and locate relevant text.

Current word and image analysis are limited in their capabilities. For example, with word-matching research tools, it is crucial to create a word limit in the query presented to the system. Furthermore, all of the words should be in without extraneous detail. However, if the input includes too many generic words, the research tool will return irrelevant social media posts that contain these generic words. This task of choosing very few, but informative words, is challenging, and the user needs prior knowledge of the field to complete the task. The user should know what information is significant or insignificant and therefore, should or should not be included in the search (i.e., contextualization), and further, the proper/accepted terminology that is best for expressing the information (i.e., lexicographical textualization). If the user fails to include the important or correct terms or includes too many irrelevant details, the searching system will not operate successfully.

Even improved analytic tools face the same challenge that word-matching research tools suffer, specifically overfilling, which is a technical term in data science related to when the observer reads too much into limited observations. The improved tools consider and search each record one at a time, independent from the rest of the records, trying to determine whether the social media contains the query or not, without paying attention to the entirety of the relevant social media posts and how they apply in different situations. This challenge of modern research tools manifests itself within the produced results.

For other tools, instead of receiving a query, a document is received from the user. Such tools process the uploaded document to extract the main subjects, and then perform a search for these subjects and returns the results. These tools can be treated as a two-step analytical engine: in the first step, the research tool extracts the main subjects of a document with methods such as word frequency, etc.; and in the second step, the research tool performs a regular search for these subjects over the world of associated social media posts. Such research tools suffer from the same problem of overfitting, sensitivity to the details, and lack of a universal measure for assessing relevance in relation to a user's query.

The results of such research tools are sensitive to the query. That is, tweaking the query in a small direction causes the results to change dramatically. The altered query may exist in a different set of case files, and therefore the results are going to be confusingly different. Moreover, since the focus of these research tools is on one document at a time, the struggle is really to combine and sort the results in terms of relevance to the query. Sorting the results is done based on how many common words exist between the query and the case file, or how similar the language of the query is to that of a case. As a result, the results run the risk of being too dependent on the details of the query and the case file, rather than concentrating on the importance of a case and its conceptual relevance to the query.

Power consumption and carbon footprints are other considerations in research systems, and thus should also be addressed. Analytic systems such as the present invention process big data. For example, when a user enters a query to a system, the system takes the query, and searches data that can be composed of tens of millions of files and websites (if not more), to find matches. This single search by itself requires a lot of resources in terms of memory to store the files, compute power to perform the search on a document, and communication to transfer the documents from a hard disk or a memory to the processor for processing. Even for a single search, a regular desktop computer may not perform the task in a timely manner, and therefore a high-performance server is required. Techniques such as database indexing make searching a database faster and more efficient; however, the process of indexing and retrieving information remain a complex, laborious and time-consuming process. As a result, a legal research tool needs a large data center to operate. Such data centers are expensive to purchase, setup, and maintain; they consume a lot of electricity to operate and to cool down; and they have large carbon footprint. It is estimated that data centers consume about 2% of electricity worldwide and that number could rise to 8% by 2030, and much of that electricity is produced from non-renewable sources, contributing to carbon emissions. A research tool can be hosted on a local data center owned by the provider of the research tool, or it can be hosted on the cloud. Either way, the equipment cost, operation cost, and electricity bill will be paid by the provider of the service one way or another. A more efficient social media analysis tool that only needs a small amount of resources, consumes less electricity per query, and has a smaller carbon footprint compared to existing tools such as those discussed above.

Other preexisting technologies do not allow for integration over multiple platforms and require permission and consent from the client to access the data on the post timelines.

As a result, more refined methods of implementing AI and machine learning to address future social media platforms as well as other content.

### BRIEF SUMMARY OF THE INVENTION

The present invention comprises systems and methods analyzing social media content using artificial intelligence/machine learning algorithms. In certain embodiments, the system collects social media data from one or more third-party social media networks associated with the user, where the social media data is comprised of two or more of post reactions, post comments, posting frequency, profile picture, public posting setting, grammar, and predetermined keywords. The system then analyzes, using a machine learning algorithm, the social media data of the user to calculate a social impact score for the user, and transmits the social impact score to the user.

In some embodiments, the social impact score is calculated relative to other social impact scores.

In certain embodiments, the system uses the neural network algorithm to analyze the social media data of the user to identify harmful content.

In yet other embodiments, the system uses the social impact score to correlate a social impact level.

In other embodiments, the machine learning algorithm is comprised of support vector machines (SVM), neural networks, Naïve Bayes classifier, and decision trees.

In some embodiments, the system stores the user's social media data to a user profile.

In other embodiments, the system updates the social impact score in real-time.

In yet other embodiment, the system outputs recommendations on improving the social impact score to the user.

### BRIEF DESCRIPTION OF THE DRAWINGS

A more complete appreciation of the invention and many of the attendant advantages thereof will be readily obtained as the same becomes better understood by reference to the following detailed description when considered in connection with the accompanying drawings, wherein:

FIG. 1 is a diagram of an exemplary embodiment of the hardware of the system of the present invention;

FIG. 2 is a diagram of an exemplary artificial intelligence algorithm as incorporated into the hardware of the system of the present invention;

FIG. 3 is a diagram showing the user consent flow in accordance with an exemplary embodiment of the invention;

FIG. 4 is a diagram of the analysis scanning (data collection) analysis and reporting/notification flow of the system of the present invention;

FIG. 5 is a diagram of a continuous flow scan in accordance with an exemplary embodiment of the invention;

FIG. 6 is a diagram of an interface for revoking user access and consent revocation subsystem flow in accordance with an exemplary embodiment of the invention; and

FIG. 7 is a diagram of the data collection flow in accordance with an exemplary embodiment of the invention.

### DETAILED DESCRIPTION OF THE PREFERRED EMBODIMENTS

In describing a preferred embodiment of the invention illustrated in the drawings, specific terminology will be resorted to for the sake of clarity. However, the invention is not intended to be limited to the specific terms so selected, and it is to be understood that each specific term includes all technical equivalents that operate in a similar manner to accomplish a similar purpose. Several preferred embodiments of the invention are described for illustrative purposes, it being understood that the invention may be embodied in other forms not specifically shown in the drawings.

Since social media posts are created by individuals on individual social media platforms, their posts need to be scanned to determine if they are possibly harmful or not. Post data across multiple platforms is collected and analyzed to determine if a post could be harmful to the client. So, the invention integrates with the social media platforms and pulls posts from the client's timelines, analyzes the posts and notifies the client of possible harmful posts.

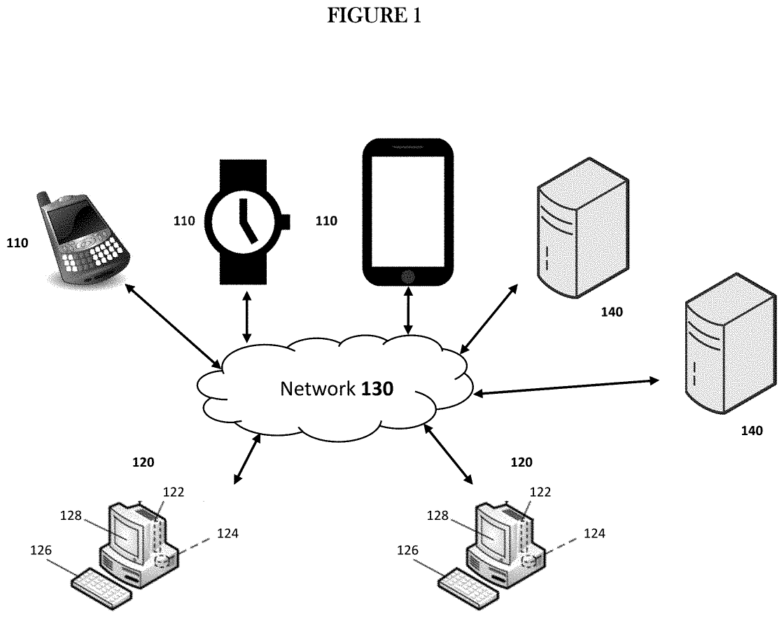

FIG. 1 is an exemplary embodiment of the social media analysis system of the present invention. In the exemplary system 100, one or more peripheral devices 110 are connected to one or more computers 120 through a network 130. Examples of peripheral devices/locations 110 include smartphones, tablets, wearables devices, and any other electronic devices that collect and transmit data over a network that are known in the art. The network 130 may be a wide-area network, like the Internet, or a local area network, like an intranet. Because of the network 130, the physical location of the peripheral devices 110 and the computers 120 has no effect on the functionality of the hardware and software of the invention. Both implementations are described herein, and unless specified, it is contemplated that the peripheral devices 110 and the computers 120 may be in the same or in different physical locations. Communication between the hardware of the system may be accomplished in numerous known ways, for example using network connectivity components such as a modem or Ethernet adapter. The peripheral devices/locations 110 and the computers 120 will both include or be attached to communication equipment. Communications are contemplated as occurring through industry-standard protocols such as HTTP or HTTPS.

Each computer 120 is comprised of a central processing unit 122, a storage medium 124, a user-input device 126, and a display 128. Examples of computers that may be used are: commercially available personal computers, open source computing devices (e.g. Raspberry Pi), commercially available servers, and commercially available portable device (e.g. smartphones, smartwatches, tablets). In one embodiment, each of the peripheral devices 110 and each of the computers 120 of the system may have software related to the system installed on it. In such an embodiment, system data may be stored locally on the networked computers 120 or alternately, on one or more remote servers 140 that are accessible to any of the peripheral devices 110 or the networked computers 120 through a network 130. In alternate embodiments, the software runs as an application on the peripheral devices 110, and include web-based software and iOS-based and Android-based mobile applications.

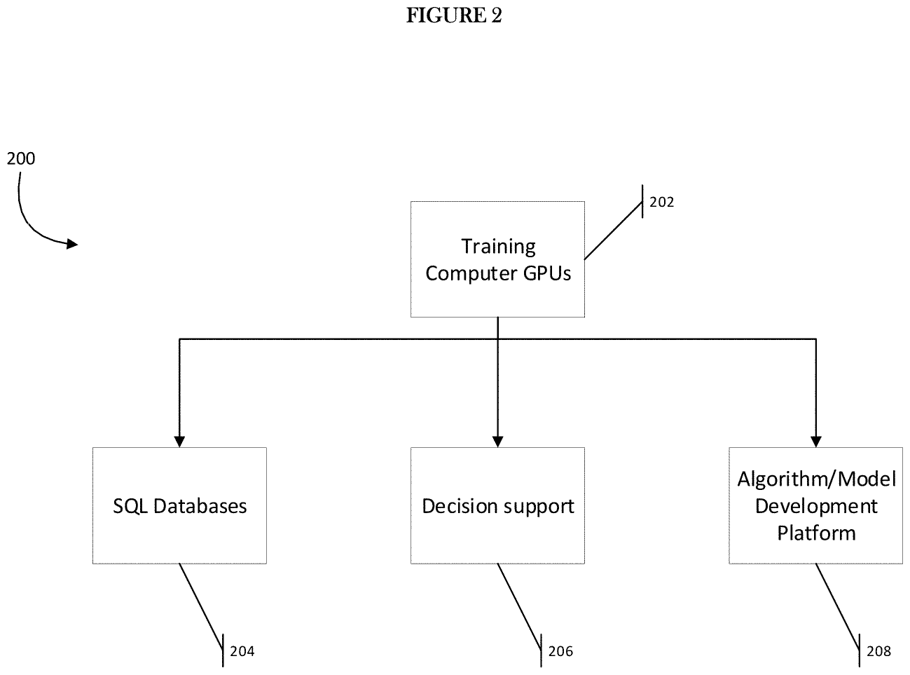

FIG. 2 describes an exemplary artificial intelligence algorithm as incorporated into the hardware of the system of the present invention. To enable the system to operate, a separate training and testing computer or computers 202 with appropriate and sufficient processing units/cores, such as graphical processing units (GPU), are used in conjunction with a database of knowledge, exemplarily an SQL database 204 (for example, comprising terms of interest in social media and their associated semantic/linguistic meanings and effect on a person's reputation), a decision support matrix 206 (for example, cross-referencing possible algorithmic decisions, system states, and third-party guidelines), and an algorithm (model) development module 208 (for example, a platform of available machine learning algorithms for testing with data sets to identify which produces a model with accurate decisions for a particular instrument, device, or subsystem). The learning algorithms of the present invention use a known dataset to thereafter make predictions. The dataset training includes input data that produces response values. The learning algorithms are then used to build predictive models for new responses to new data. The larger the training datasets, the better will be the prediction models. The algorithms contemplated include support vector machines (SVM), neural networks, Naïve Bayes classifier and decision trees. The learning algorithms of the present invention may also incorporate regression algorithms include linear regression, nonlinear regression, generalized linear models, decision trees, and neural networks. The invention comprises of different model architectures such as convolutional neural networks, tuned for specific content types such as image, text and emojis, and video, as well as text-in-image, text-in-video, audio transcription and relational context of multimedia posts.

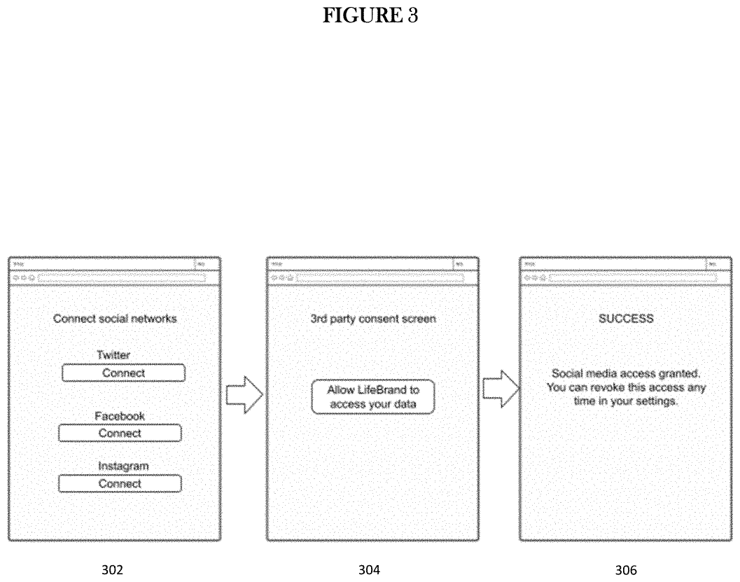

FIG. 3 is a diagram showing the user consent flow in accordance with an exemplary embodiment of the invention. FIG. 3 therefore describes an exemplary protocol for the system of the present invention to obtain authorization from a user prior to performing any analysis of the user's social media. Before any data is collected or analyzed, the user is asked to consent to data collection. Without user consent, no data is stored, nor analyzed. At a first screen 302, a user is prompted to connect his or her social networks to the social media analysis system. The user can connect such social media as Twitter, Facebook, and Instagram to the system. Other social media networks known in the art are also contemplated as being within the scope. Upon approving the connection to a social media network, the user is taken to a third-party consent screen 304. At this screen, the user is asked to verify and affirmatively grant access to his or her social media data to the system of the present invention. Upon granting access to that social media network and its data, the user is returned to a success screen 306, where the system notifies the user that access to his or her social media data has been granted.

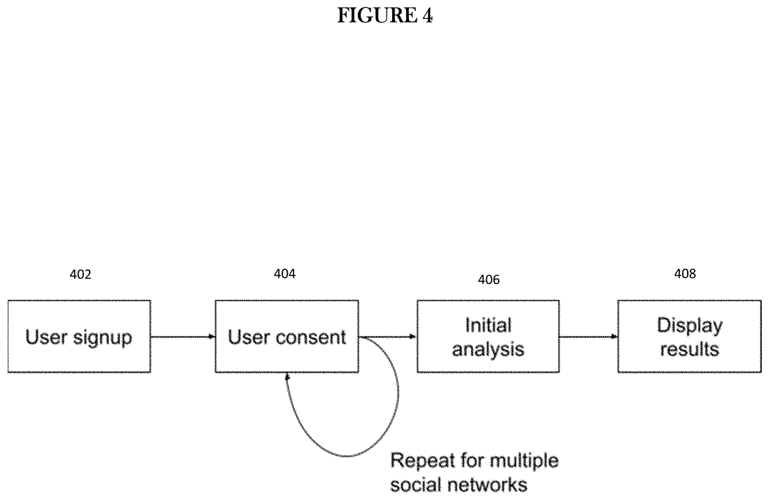

FIG. 4 is a diagram of the analysis scanning (data collection) analysis and reporting/notification flow of the system of the present invention. The process commences at User signup 402, where the user is prompted to sign up for the services provided by the system of the present invention. The system next attempts to obtain user consent 404 for data, as explained with regard to FIG. 3 above. User consent 404 is obtained for one or more social networks, and the steps of FIG. 3 are repeated as necessary for multiple social networks. Once the user's data is collected by the system, an initial analysis is performed to identify unfavorable social media posts or other objectionable data. Unfavorable and objectionable data is identified using a machine learning algorithm, as exemplarily described with respect to FIG. 2 above. Once the user's social media has been analyzed for unfavorable or objectionable data, the results of the analysis are displayed 408.

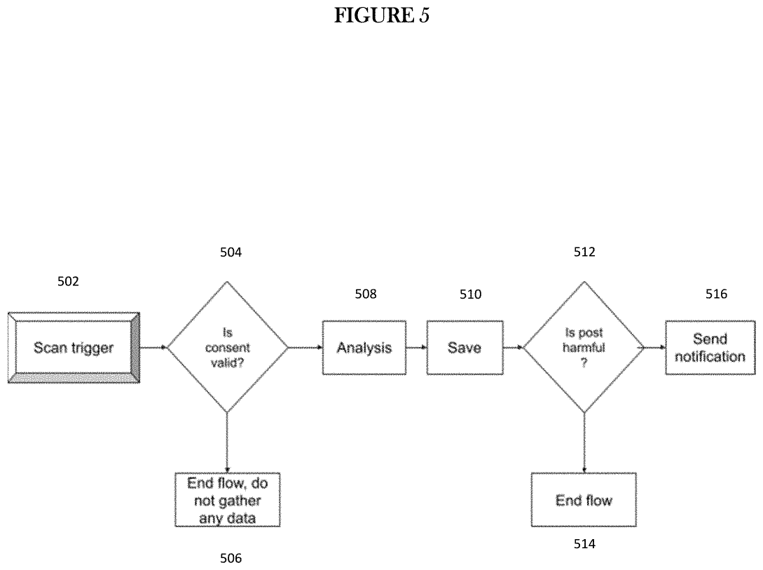

FIG. 5 is a diagram of a continuous flow scan in accordance with an exemplary embodiment of the invention. In certain cases, the system may also perform a continuous scan of the user's social media. The process commences at the scan trigger 502, which can be any predetermined reason to begin a scan of the user's social media. A continuous scan can be triggered by time, detection of an individual post, or change in the analysis algorithm. Regardless of the origin of the scan, the validity of the consent is always checked 504. If consent is determined to not have been granted by the user, the process ends 506, and the system does not collect or analyze any data for the user. If the user has granted the system access to his or her social media data, then the system performs an analysis of the user's social media 508, applying the machine learning algorithms described with regard to FIG. 2 to identify unfavorable or objectionable data. Words, phrases, images, videos, text and audio from image and video are all taken from user social media to perform the analysis. The determinations of the algorithm are saved to the user's profile 510. Those determinations include whether the user post is potentially harmful, and also what category of harmful post it falls under. The system then determines based on the analysis, whether the social media post is harmful 512. If the system determines that there are no harmful posts presents, the system process ends 514. However, if the system determines that there is a harmful post present, it notifies the user 516 so that the user may remove it.

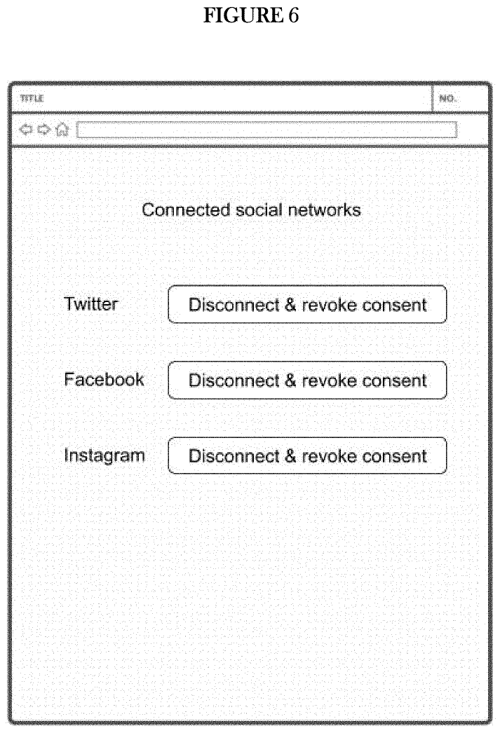

FIG. 6 is a diagram of an interface for revoking user access and consent revocation subsystem flow in accordance with an exemplary embodiment of the invention. Users are presented with an option to revoke granted permissions to individual third-party social networks. The networks include Twitter, Facebook, Instagram, as well as any other social networks known in the art. Other social media platforms can be added as it makes sense to do so. After revoking permission, all the data connected to the user is anonymized and the data is no longer used to analyze users' data.

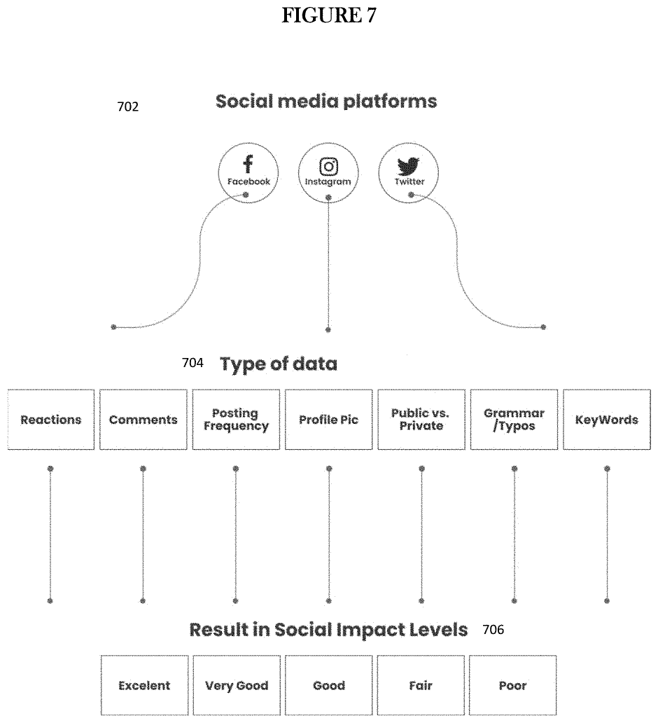

FIG. 7 is a diagram of the data collection flow in accordance with an exemplary embodiment of the invention. The data collection flow is used to collect the information that is used to calculate a standardized Social Impact Score for users. Social Impact Score is a data-driven scoring system that analyzes data from multiple social media accounts (not limited to Facebook, Instagram and Twitter) and determines how well users manage their online presence and online personal brand. It also provides the user with suggestions and tips on how to improve their online presence and personal brand.

In order to calculate the score, multiple user parameters from different media have been identified. Each of them has a different assigned weight and threshold as a part of the Social Impact Score calculation. Table 1 lists exemplary parameters and their associated individual scores that are used to calculate the Social Impact Score. The Social Impact Score may be updated in real-time as the user adds to or removes social media content from the Internet.

TABLE 1

| | SM 1 | | SM 2 | | SM 3 | | Description |
|---|---|---|---|---|---|---|---|
| Reactions | >a1% | A1 | >a2% | A2 | >a3% | A3 | Average number of |
| | >b1% | B1 | >b2% | B2 | >b3% | B3 | reactions the user is |
| | >c1% | C1 | >c2% | C2 | >c3% | C3 | getting to their |
| | >d1% | D1 | >d2% | D2 | >d3% | D3 | Social Media posts |
| | >e1% | E1 | >e2% | E2 | >e3% | E3 | compared to the |
| | | | | | | | total number of |
| | | | | | | | followers |
| Comments | >a1% | A1 | >a2% | A2 | >a3% | A3 | Average number of |
| | b1-b1′% | B1 | b2-b2′% | B2 | b3-b3′% | B3 | comments that the |
| | c1-c1′% | C1 | c2-c2′% | C2 | c3-c3′% | C3 | user is engaging |
| | <d1% | D1 | <d2% | D2 | <d3% | D3 | with in form of |
| | | | | | | | comments/reactions |
| | | | | | | | compared to the |
| | | | | | | | total number of |
| | | | | | | | comments he got |
| Posting | a1-a1′ | A1 | a2-a2′ | A2 | a3-a3′ | A3 | Average number of |
| Frequency | per week | | per week | | per week | | posts the user is |
| | b1-b1′ | B1 | b2-b2′ | B2 | b3-b3′ | B3 | posting weekly |
| | per week | | per week | | per week | | |
| | c1 per day | C1 | c2 per day | C2 | c3 per day | C3 | |
| | d1+ | D1 | d2+ | D2 | d3+ | D3 | |
| | per week | | per week | | per week | | |
| | e1 per | E1 | e2 per | E2 | e3 per | E3 | |
| | week | | week | | week | | |
| Profile Pic | Yes | A1 | Yes | Yes | >a3% | A3 | Does the user have |
| | No | B2 | No | No | >b3% | B3 | a profile picture? |
| Public vs. | Public | A1 | Public | A2 | Public | A3 | Is the user′s profile |
| Private | Private | B2 | Private | B2 | Private | B3 | public or private? |
| Grammar/Typos | >a1% | A1 | >a2% | A2 | >a3% | A3 | Number of posts |
| | >b1-b1′% | B1 | >b2-b2′% | B2 | >b3-b3′% | B3 | that are |
| | >c1-c1′% | C1 | >c2-c2′% | C2 | >c3-c3′% | C3 | grammatically |
| | >d1-d1′% | D1 | >d2-d2′% | D2 | >d3-d3′% | D3 | incorrect or include |
| | <e1% | E1 | <e2% | E2 | <e3% | E3 | typos compared to |
| | | | | | | | the total number of |
| | | | | | | | posts that the user |
| | | | | | | | shared |
| KeyWords | >a1% | A1 | >a2% | A2 | >a3% | A3 | Number of posts |
| | >b1-b1′% | B1 | >b2-b2′% | B2 | >b3-b3′% | B3 | that have harmful |
| | >c1-c1′% | C1 | >c2-c2′% | C2 | >c3-c3′% | C3 | words in them |
| | >d1-d1′% | D1 | >d2-d2′% | D2 | >d3-d3′% | D3 | compared to the |
| | <e1% | E1 | <e2% | E2 | <e3% | E3 | total number of |
| | | | | | | | posts the user |
| | | | | | | | shared |

| | | | | |
|---|---|---|---|---|
| MAX TOTAL | M | N | O | P |
| MIN TOTAL | Q | R | S | T |

With reference to the above, in order to calculate the Social Impact Score, multiple user parameters from different media have been identified. Each of them has a different assigned weight and threshold. The combined data of all of them renders the total Score. An exemplary equation for calculating Social Impact Score is provided below, where the Greek characters represent the weight and threshold, which may be adjusted by one of ordinary skill in the art:

Social Impact Score=α*(Reactions)+β*(Comments)+γ*(Posting Frequency)+δ*(Profile Pic)+ε*(Public vs. Private)+ζ*(Grammar/Typos)+η*(KeyWords)

In the table, “SM1” refers to a first social media platform, “SM2” refers to a second social media platform, and “SM3” refers to a third social media platform, where each platform is different.

With regard to the “Reactions” category, the content on each social media platform may be evaluated to identify the average number of reactions the user is getting to their social media posts compared to the total number of followers, which is compared to individual scores cutoffs or ranges a1 through e3 as shown in the table. Then, a numerical value A1 through E3 is calculated. For example, if the average number of reactions is identified for SM1 to be 9-percent, and if a1 is any value greater than 8.6, then A could be assigned a score of 100. Each social media account could use different cutoff; that is a1, a2 and a3 may use different cutoffs or ranges. Likewise, the assigned values A1, A2, and A3 may be different, depending on the relative weighting used for each social media platform.

TABLE 2

| | |
|---|---|
| EXCELLENT | V1-V2 |
| VERY GOOD | W1-W2 |
| GOOD | X1-X2 |
| FAIR | Y1-Y2 |
| POOR | Z1-Z3 |

Table 2 is a diagram showing a possible social impact ranking rubric whereby the social impact score ranking results obtained according to the assigned values in Table 1 are obtained. As shown, the final score is obtained, based on the predetermined categorization by levels. For example, based on the total scores assigned to SM1, SM2, and SM3, the combined scores for all three social media platforms is compared to the table values in Table 2. If the combined score falls in the range V1 to V2, the user's Social Impact Score may be characterized as being “excellent” (or some other characterization used instead of “excellent”). If the combined score falls in the range W1 through W2, the user's Social Impact Score may be characterized as being “very good” (or some other characterization used instead of “very good”), etc.

The foregoing description and drawings should be considered as illustrative only of the principles of the invention. The invention is not intended to be limited by the preferred embodiment and may be implemented in a variety of ways that will be clear to one of ordinary skill in the art. Numerous applications of the invention will readily occur to those skilled in the art. Therefore, it is not desired to limit the invention to the specific examples disclosed or the exact construction and operation shown and described. Rather, all suitable modifications and equivalents may be resorted to, falling within the scope of the invention.

1. A computer-implemented method comprising:
collecting social media data from one or more third-party social media networks associated with the user, wherein the social media data is comprised of two or more of post reactions, post comments, posting frequency, profile picture, public posting setting, grammar, and predetermined keywords;
analyzing, using a machine learning algorithm, the social media data of the user to calculate a social impact score for the user; and
transmitting the social impact score to the user, wherein the social impact score is calculated relative to other social impact scores.

2. The method of claim 1, further comprising analyzing, using the neural network algorithm, the social media data of the user to identify harmful content.

3. The method of claim 1, wherein the social impact score is correlated to a social impact level.

4. The method of claim 1, wherein the machine learning algorithm is comprised of support vector machines (SVM), neural networks, Naïve Bayes classifier, and decision trees.

5. The method of claim 1, further comprising storing the user's social media data to a user profile.

6. The method of claim 1, further comprising updating the social impact score in real-time.

7. The method of claim 1, further comprising outputting recommendations on improving the social impact score.

8. A computer-readable storage medium having computer-executable instructions stored thereupon which, when executed by one or more processors of a computing device, cause the one or more processors of the computing device to:
collect social media data from one or more third-party social media networks associated with the user, wherein the social media data is comprised of two or more of post reactions, post comments, posting frequency, profile picture, public posting setting, grammar, and predetermined keywords;
analyze, using a machine learning algorithm, the social media data of the user to calculate a social impact score for the user; and
transmit the social impact score to the user, wherein the social impact score is calculated relative to other social impact scores.

9. The computer-readable storage medium of claim 8, wherein the one or more processors analyze, using the neural network algorithm, the social media data of the user to identify harmful content.

10. The computer-readable storage medium of claim 8, wherein the social impact score is correlated to a social impact level.

11. The computer-readable storage medium of claim 8, wherein the machine learning algorithm is comprised of support vector machines (SVM), neural networks, Naïve Bayes classifier, and decision trees.

12. The computer-readable storage medium of claim 8, wherein the one or more processors store the user's social media data to a user profile.

13. The computer-readable storage medium of claim 8, wherein the one or more processors update the social impact score in real-time.

14. The computer-readable storage medium of claim 8, wherein the one or more processors output recommendations on improving the social impact score.
